(19) United States
(12) Patent Application Publication
(10) Pub. No.: US 2026/0159118 A1
(43) Pub. Date: Jun. 11, 2026

(54) DYNAMIC CONDITION-BASED POINT CLOUD GENERATION FOR AUTONOMOUS DRIVING

(71) Applicant: GM Global Technology Operations LLC, Detroit, MI (US)

(72) Inventors: Sai Vishnu Aluru, Commerce Twp, MI (US); Alison Bayzat, South Lyon, MI (US); Nadia Abousaleh, Dearborn, MI (US)

(73) Assignee: GM Global Technology Operations LLC, Detroit, MI (US)

(21) Appl. No.: 18/975,627

(22) Filed: Dec. 10, 2024

(51) Int. Cl. B60W 60/00; B60W 50/14

(52) U.S. Cl. CPC B60W 60/001; B60W 50/14; B60W 2050/143; B60W 2420/403; B60W 2420/408; B60W 2520/00; B60W 2555/20

(57) ABSTRACT

A method includes determining, using a light detection and ranging (LiDAR) system, a first point cloud representing an environment of a vehicle, determining, based on the first point cloud, an autonomous driving scenario of the vehicle, and determining one or more conditions associated with the autonomous driving scenario. The method also includes determining, based on the autonomous driving scenario and the one or more conditions, one or more extrinsic parameters for the LiDAR system, the one or more extrinsic parameters for the LiDAR system representing a geometric relationship between the LiDAR system and the vehicle, and re-configuring the LiDAR system based on the one or more extrinsic parameters. The method further includes determining, using the re-configured LiDAR system, a second point cloud representing an environment of the vehicle, and autonomously operating, using the second point cloud, the vehicle.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

Autonomous driving (e.g., level 4 autonomous driving) leverages light detection and ranging (LiDAR) technology to navigate and understand an environment in which a vehicle is operating with high precision. A LiDAR system emits laser pulses that bounce off surrounding objects and return to a sensor of the LiDAR system. When these laser pulses return to the LiDAR system, the time it takes for each pulse to return is measured, allowing the LiDAR system to calculate the distance to each object with high accuracy. By continuously scanning the environment in all directions, LiDAR can generate a comprehensive panoramic point cloud, which is a dense collection of data points that represent the three-dimensional (3D) positions of objects around the vehicle over time as the vehicle moves and/or conditions or the environment change. This point cloud may then be processed over time to construct detailed and dynamic 3D maps (i.e., a four-dimensional (4D) map), which is essential for the vehicle to understand its environment, identify obstacles, and navigate safely. The high resolution and accuracy of LiDAR-generated 4D maps enable autonomous vehicles to make precise decisions (e.g., regarding speed, maneuvers, etc.) in real-time, enhancing their ability to operate reliably in complex and changing environments. LiDAR's ability to function effectively in various lighting conditions, including complete darkness, makes it an indispensable tool for the development of reliable and robust self-driving systems.

The present disclosure relates generally to dynamic condition-based point cloud generation for autonomous driving.

### SUMMARY

One aspect of the disclosure provides a vehicle including a light detection and ranging (LiDAR) system, data processing hardware, and memory hardware in communication with the data processing hardware and storing instructions that, when executed by the data processing hardware, cause the data processing hardware to perform operations. The operations include determining, using the LiDAR system, a first point cloud representing an environment of the vehicle, determining, based on the first point cloud, an autonomous driving scenario of the vehicle, and determining one or more conditions associated with the autonomous driving scenario. The operations also include determining, based on the autonomous driving scenario and the one or more conditions, one or more extrinsic parameters for the LiDAR system, the one or more extrinsic parameters for the LiDAR system representing a geometric relationship between the LiDAR system and the vehicle, and re-configuring the LiDAR system based on the one or more extrinsic parameters. The operations further include determining, using the re-configured LiDAR system, a second point cloud representing an environment of the vehicle, and autonomously operating, using the second point cloud, the vehicle.

Implementations of the disclosure may include one or more of the following optional features. In some implementations, the operations also include, while the LiDAR system is being re-configured, obtaining image data using a camera and using the image data to autonomously operate the vehicle. In some examples, determining the one or more extrinsic parameters for the LiDAR system includes determining the one or more extrinsic parameters to reduce a latency associated with determining a panoramic point cloud image for autonomously operating the vehicle. In some implementations, determining the one or more extrinsic parameters for the LiDAR system is also based on one or more intrinsic parameters of the LiDAR system.

In some examples, the operations also include determining, based on the autonomous driving scenario, one or more extrinsic parameters for a camera of the vehicle, the one or more extrinsic parameters for the camera representing a geometric relationship between the camera and the vehicle, and re-configuring the camera based on the one or more extrinsic parameters for the camera. The operations further include obtaining image data using the re-configured camera and using the image data together with the second point cloud to autonomously operate the vehicle.

In some implementations, the vehicle also includes a human-machine interface (HMI), and the operations also include detecting, based on the first point cloud, an object in a path of the vehicle, and, based on detecting the object in the path of the vehicle, alerting an operator of the vehicle of the object in the path of the vehicle in the HMI and soliciting, via the HMI, from the operator, a permission to proceed with autonomous driving. Alerting the operator may include displaying the object in the HMI such that a colorblind operator can perceive the object. In some examples, the autonomous driving scenario of the vehicle includes at least one of an environmental condition of the vehicle, a road state, a weather state, a detected object, an operating state of the vehicle, a vehicle speed, a location of the vehicle, or a path of the vehicle.

Another aspect of the disclosure provides a computer-implemented method executed on data processing hardware that causes the data processing hardware to perform operations. The operations include determining, using the LiDAR system, a first point cloud representing an environment of the vehicle, determining, based on the first point cloud, an autonomous driving scenario of the vehicle, and determining one or more conditions associated with the autonomous driving scenario. The operations also include determining, based on the autonomous driving scenario and the one or more conditions, one or more extrinsic parameters for the LiDAR system, the one or more extrinsic parameters for the LiDAR system representing a geometric relationship between the LiDAR system and the vehicle, and re-configuring the LiDAR system based on the one or more extrinsic parameters. The operations further include determining, using the re-configured LiDAR system, a second point cloud representing an environment of the vehicle, and autonomously operating, using the second point cloud, the vehicle.

Implementations of the disclosure may include one or more of the following optional features. In some implementations, the operations also include, while the LiDAR system is being re-configured, obtaining image data using a camera and using the image data to autonomously operate the vehicle. In some examples, determining the one or more extrinsic parameters for the LiDAR system includes determining the one or more extrinsic parameters to reduce a latency associated with determining a panoramic point cloud image for autonomously operating the vehicle.

In some examples, determining the one or more extrinsic parameters for the LiDAR system is also based on one or more intrinsic parameters of the LiDAR system. In some implementations, the operations also include detecting, based on the first point cloud, an object in a path of the vehicle and, based on detecting the object in the path of the vehicle, alerting an operator of the vehicle of the object in the path of the vehicle in a human-machine interface (HMI) of the vehicle, soliciting, via the HMI, from the operator, a permission to proceed with autonomous driving.

In some implementations, the operations also include determining, based on the autonomous driving scenario, one or more extrinsic parameters for a camera of the vehicle, the one or more extrinsic parameters for the camera representing a geometric relationship between the camera and the vehicle. The operations also include re-configuring the camera based on the one or more extrinsic parameters for the camera, obtaining image data using the re-configured camera, and using the image data together with the second point cloud to autonomously operate the vehicle.

Yet another aspect of the disclosure provides a system including data processing hardware, and memory hardware in communication with the data processing hardware and storing instructions that, when executed by the data processing hardware, cause the data processing hardware to perform operations. The operations include determining, using the LiDAR system, a first point cloud representing an environment of the vehicle, determining, based on the first point cloud, an autonomous driving scenario of the vehicle, and determining one or more conditions associated with the autonomous driving scenario. The operations also include determining, based on the autonomous driving scenario and the one or more conditions, one or more extrinsic parameters for the LiDAR system, the one or more extrinsic parameters for the LiDAR system representing a geometric relationship between the LiDAR system and the vehicle, and re-configuring the LiDAR system based on the one or more extrinsic parameters. The operations further include determining, using the re-configured LiDAR system, a second point cloud representing an environment of the vehicle, and autonomously operating, using the second point cloud, the vehicle.

Implementations of the disclosure may include one or more of the following optional features. In some implementations, the operations also include, while the LiDAR system is being re-configured, obtaining image data using a camera and using the image data to autonomously operate the vehicle. In some examples, determining the one or more extrinsic parameters for the LiDAR system includes determining the one or more extrinsic parameters to reduce a latency associated with determining a panoramic point cloud image for autonomously operating the vehicle.

In some examples, determining the one or more extrinsic parameters for the LiDAR system is also based on one or more intrinsic parameters of the LiDAR system. In some implementations, the operations also include detecting, based on the first point cloud, an object in a path of the vehicle and, based on detecting the object in the path of the vehicle, alerting an operator of the vehicle of the object in the path of the vehicle in a human-machine interface (HMI) of the vehicle, soliciting, via the HMI, from the operator, a permission to proceed with autonomous driving.

In some implementations, the operations also include determining, based on the autonomous driving scenario, one or more extrinsic parameters for a camera of the vehicle, the one or more extrinsic parameters for the camera representing a geometric relationship between the camera and the vehicle. The operations also include re-configuring the camera based on the one or more extrinsic parameters for the camera, obtaining image data using the re-configured camera, and using the image data together with the second point cloud to autonomously operate the vehicle.

### BRIEF DESCRIPTION OF THE DRAWINGS

The drawings described herein are for illustrative purposes only of selected configurations and are not intended to limit the scope of the present disclosure.

FIG. 1 is a view of an example vehicle incorporating an autonomous driving system in accordance with the principles of the present disclosure.

FIG. 2 is a schematic view of the autonomous driving system of FIG. 1.

FIG. 3A illustrates an example re-configuration of a LiDAR system.

FIG. 3B illustrates another example re-configuration of a LiDAR system.

FIGS. 4A and 4B are a flowchart of an example arrangement of operations for a method of dynamic condition-based point cloud generation for autonomous driving.

FIG. 5 is a flowchart of another example arrangement of operations for a method of dynamic condition-based point cloud generation for autonomous driving.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an application specific integrated circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Unless expressly stated to the contrary, the phrase “at least one of A, B, or C” is intended to refer to any combination or subset of A, B, C such as: (1) at least one A alone; (2) at least one B alone; (3) at least one C alone; (4) at least one A with at least one B; (5) at least one A with at least one C; (6) at least one B with at least C; and (7) at least one A with at least one B and at least one C. Moreover, unless expressly stated to the contrary, the phrase “at least one of A, B, and C” is intended to refer to any combination or subset of A, B, C such as: (1) at least one A alone; (2) at least one B alone; (3) at least one C alone; (4) at least one A with at least one B; (5) at least one A with at least one C; (6) at least one B with at least one C; and (7) at least one A with at least one B and at least one C. Furthermore, unless expressly stated to the contrary, “A or B” is intended to refer to any combination of A and B, such as: (1) A alone; (2) B alone; and (3) A and B.

Autonomous driving (e.g., level 4 autonomous driving) leverages light detection and ranging (LiDAR) technology to navigate and understand an environment in which a vehicle is operating with high precision. A LiDAR system emits laser pulses that bounce off surrounding objects and return to a sensor of the LiDAR system. When these laser pulses return to the LiDAR system, the time it takes for each pulse to return is measured, allowing the LiDAR system to calculate the distance to each object with high accuracy. By continuously scanning the environment in all directions, LiDAR can generate a comprehensive panoramic point cloud, which is a dense collection of data points that represent the three-dimensional (3D) positions of objects around the vehicle over time as the vehicle moves and/or conditions or the environment change. This point cloud may then be processed over time to construct detailed and dynamic 3D maps (i.e., a four-dimensional (4D) map), which is essential for the vehicle to understand its environment, identify obstacles, and navigate safely. The high resolution and accuracy of LiDAR-generated 4D maps enable autonomous vehicles to make precise decisions (e.g., regarding speed, maneuvers, etc.) in real-time, enhancing their ability to operate reliably in complex and changing environments. LiDAR's ability to function effectively in various lighting conditions, including complete darkness, makes it an indispensable tool for the development of reliable and robust self-driving systems.

However, the packaging and placement of LiDAR systems for a vehicle can be challenging. For example, to minimize or eliminate blind zones and/or to meet the requirements for safe autonomous driving. Therefore, there is a need for improved LiDAR systems. Disclosed LiDAR systems can be conditionally (re-)configured in real time based on dynamically detected driving scenario conditions or environment by modifying or (re-)configuring their extrinsic parameters in real time. That is, by dynamically changing their relative geometric relationships to a vehicle responsive to changing driving conditions, environment, and scenarios. For example, by changing their direction, or by changing an intrinsic parameter of the LiDAR system. In particular, LiDAR systems may be continuously (re-)configured based on a driving scenario (e.g., highway, urban driving, parking lot, etc.) to achieve the most efficient, useful, and accurate results. In disclosed embodiments, LiDAR field-of-view (FOV) may be dynamically adjusted while a vehicle is being autonomously operated to more efficiently perform an autonomous driving sequence, by prioritizing the FOV with required data. Additionally, or alternatively, camera imagery may be used to maintain autonomy while LiDAR is being scrutinized for latency reduction during conditional alignment of a LiDAR system. Disclosed configurations provide a number of advantages including, for example: an ability to perform pre-flight checks to achieve additional FOV coverage (dripline, blind zone); dynamic alignment of LiDAR to optimize for use cases (e.g., highway vs. urban setting with vulnerable road users (VRUs)); reduction in system time needed to detect and classify objects by performing dynamic changes on the go; improve customer experience and safety by eliminating any hardware limitations and providing redundancy for object detection through point cloud/sensor fusion; and improve the confidence rate of autonomous driving solution through sensor redundancy.

While configurations are shown and described herein in connection with a vehicle (e.g., an automobile, a truck, an airplane, a train, a motorcycle, etc.), it should be understood that disclosed configurations may, additionally or alternatively, be used for generating a point cloud for any other type of device (e.g., a drone, a robot, a bicycle, equipment, etc.). Here, a vehicle or device may be operated by a person or may operate independently.

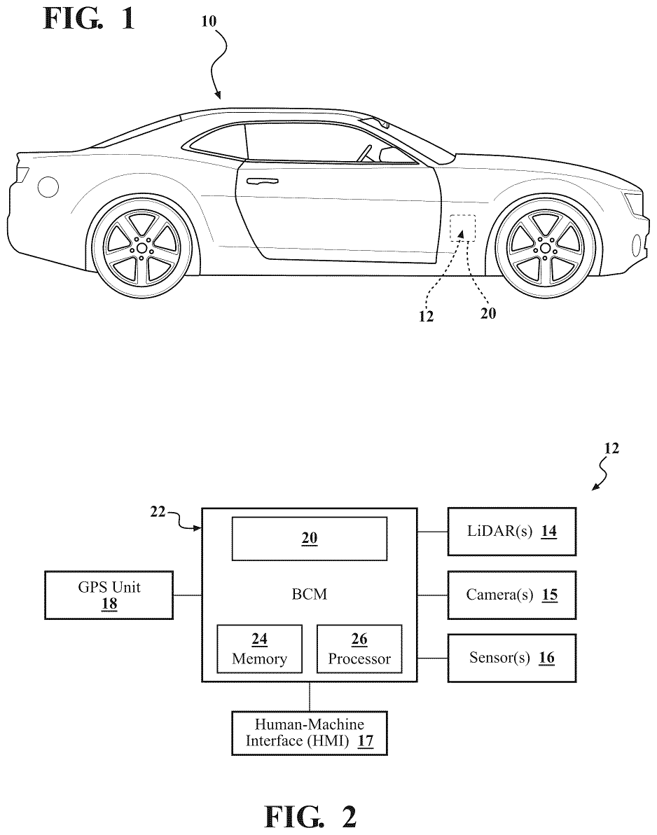

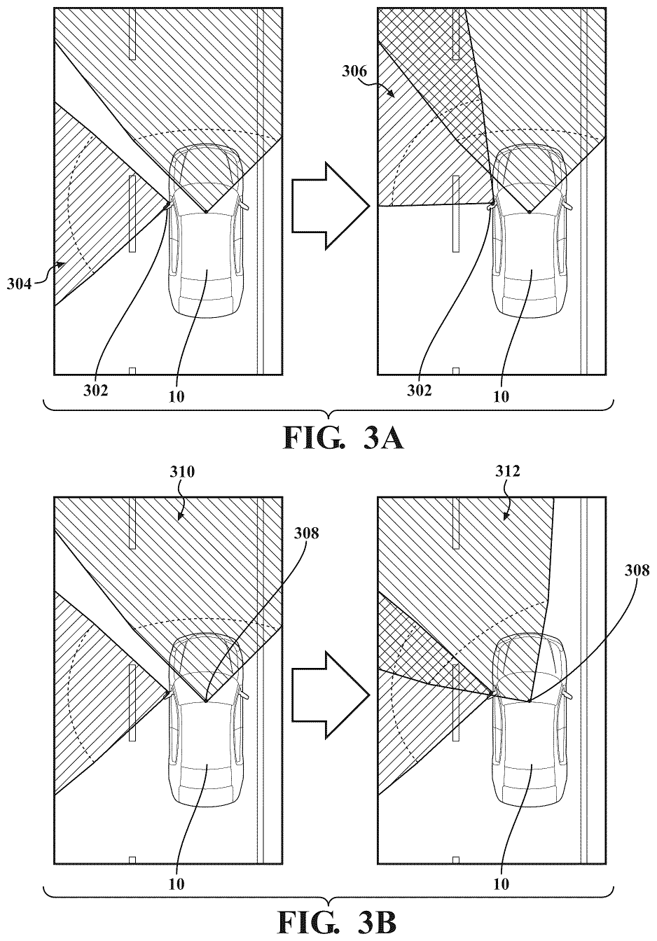

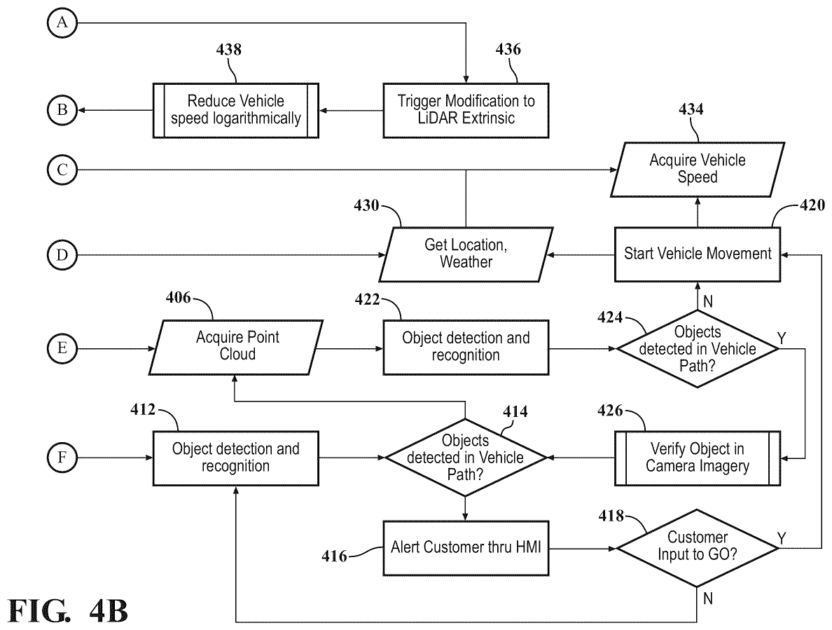

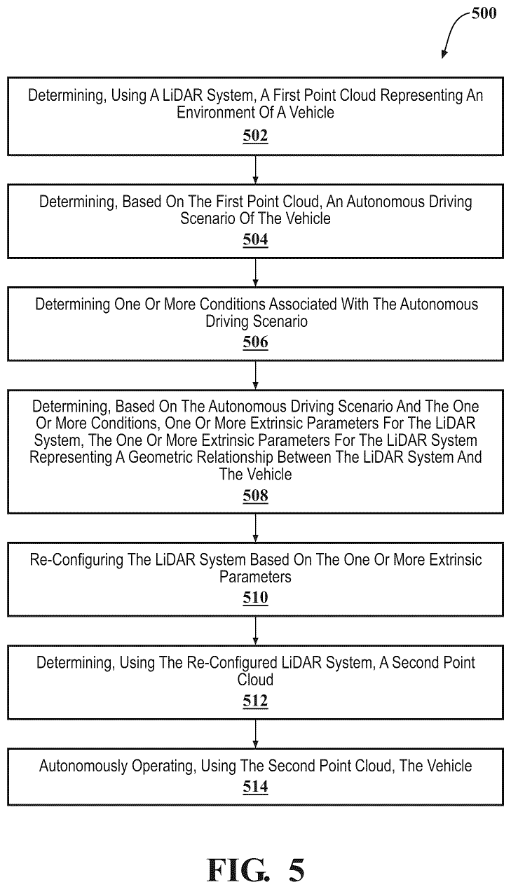

With particular reference to FIGS. 1 and 2, a vehicle 10 (e.g., an automobile, a truck, an airplane, a train, a motorcycle, etc.) is shown in conjunction with an autonomous driving system 12. As will be described in greater detail below, the autonomous driving system 12 may be used to perform, in addition to other functions, dynamic condition-based point cloud generation for autonomous driving. The autonomous driving system 12 includes a dynamic point cloud generation module 20 that may be stored and executed by, for example, a body control module (BCM) 22 of the vehicle 10. Specifically, the BCM 22 may store instructions for executing the operations shown in FIGS. 4 and 5 on, for example, memory hardware 24. The instructions may be executed by data processing hardware (e.g., a processor 26) of the BCM 22 to perform the operations.

The dynamic point cloud generation module 20 is configured to, responsive to a detected autonomous driving scenario of the vehicle 10 being performed by the autonomous driving system 12, an environment of the vehicle 10 and conditions, dynamically control one or more LiDAR systems 14 and/or one or more cameras 15 for generating point clouds (e.g., panoramic point clouds) representing an environment of the vehicle 10. In particular, the dynamic point cloud generation module 20 determines, using the LiDAR system(s) 14, a first point cloud that represents an environment of the vehicle 10, determines, based on the point cloud, an autonomous driving scenario of the vehicle 10, and determines one or more conditions associated with the autonomous driving scenario. Here, the one or more conditions may be determined using, for example, one or more cameras 15 and/or one or more sensors 16. The dynamic point cloud generation module 20 then determines, based on the autonomous driving scenario, the environment, and the one or more conditions, one or more extrinsic parameters for the LiDAR system(s) 14. Here, the one or more extrinsic parameters for the LiDAR system(s) 14 represent a geometric relationship between the LiDAR system(s) 14 and the vehicle 10. The dynamic point cloud generation module 20 re-configures the LiDAR system(s) 14 based on the one or more extrinsic parameters. Thereafter, the dynamic point cloud generation system 20 determines, using the re-configured LiDAR system, a second point cloud representing an environment of the vehicle 10, and the autonomous driving system 12 uses the second point cloud to autonomously operate the vehicle 10. Here, the autonomous driving scenario of the vehicle 10 may include one or more of an environmental condition of the vehicle, a weather state, a road state, a detected object, an operating state of the vehicle, a vehicle speed, or a location of the vehicle.

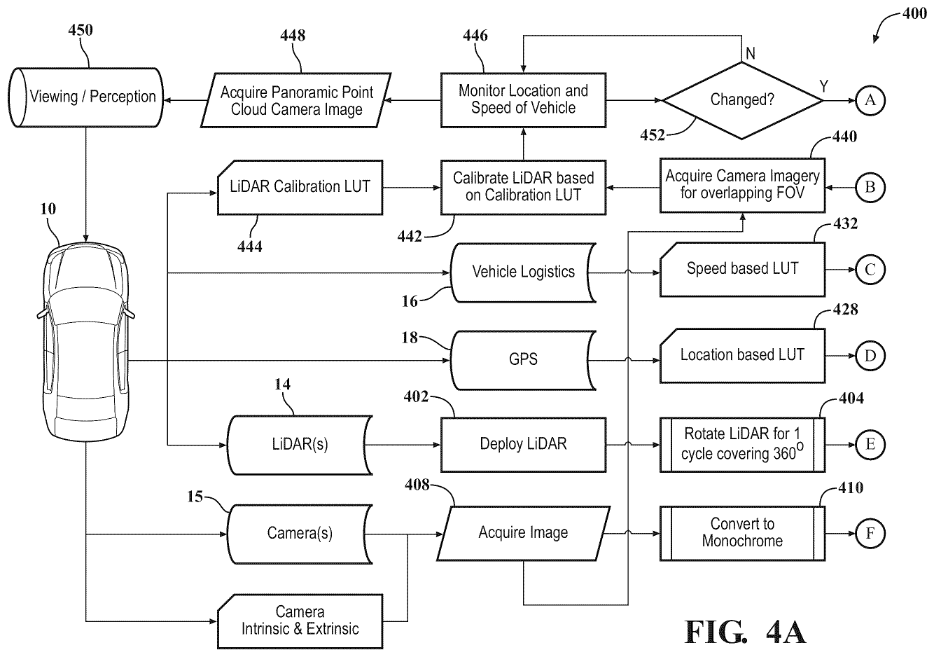

FIG. 3A illustrates an example re-configuration of a LiDAR system 14. In this example, as the vehicle 10 moves forward, a LiDAR system 14 on a side-view mirror 302 is re-configured from a side facing zone 304 to a right-front facing zone 306.

FIG. 3B illustrates another example re-configuration of a LiDAR system 14. In this example, as the vehicle 10 moves forward, a LiDAR system 14 on a rear-view mirror 308 is re-configured from a front facing zone 310 to a right-front facing zone 312.

FIGS. 4A and 4B are a flowchart of an example arrangement of operations for a method of dynamic condition-based point cloud generation for autonomous driving (e.g., level 4 autonomous driving). The operations may be performed by data processing hardware (e.g., the processor 26) based on executing instructions stored on memory (e.g., the memory hardware 24). Many other ways of implementing the method 400 may be employed. For example, the order of execution of the operations may be changed, and/or one or more of the operations and/or interactions may be changed, eliminated, sub-divided, or combined. Additionally, the operations of FIGS. 4A and 4B may be carried out sequentially and/or in parallel by, for example, separate processing threads, processors, devices, discrete logic, circuits, etc.

At operation 402, the method 400 includes deploying or activating a LiDAR system 14. At operation 404, the method 400 includes rotating the LiDAR system 14 through 360 degrees. At operation 406, the method 400 includes generating or acquiring a point cloud (e.g., a panoramic point cloud) based on data captured by the rotating LiDAR system 14.

At operation 408, the method 400 includes acquiring image data (i.e., an image). At operation 410, the method 400 may include converting the image data to monochrome image data. At operation 412, the method 400 includes performing, based on the image data, object detection and/or recognition. At operation 414, if no object was detected in a path of the vehicle 10, the method 400 proceeds to operation 406. However, at operation 416, if an object was detected in the vehicle's path, the method 400 includes notifying an operator of the vehicle 10 of the detected object in a human-machine interface (HMI) 17 (see FIG. 2) of the vehicle 10, and soliciting, via the HMI 17, from the operator, permission to proceed with autonomous driving. Here, alerting or notifying the operator may include displaying an image of the object in the HMI 17 such that a colorblind operator can perceive the object. At operation 418, the method 400 includes determining whether the operator indicates that autonomous driving may start/continue. If autonomous driving may not start/continue, the method 400 includes returning to operation 412. However, if autonomous driving may start/continue, at operation 420, the method 400 includes starting autonomous driving operation (e.g., level 4 autonomous driving).

At operation 422, the method 400 includes performing, based on the point cloud, object detection and/or recognition. At operation 424, if no object was detected in a path of the vehicle 10, the method 400 proceeds to operation 420. At operation 426, if an object was detected in the vehicle's path, the method 400 may include verifying that the object is detected in the image data.

At operation 430, the method 400 includes using Global Positioning System (GPS) data from a GPS unit 18 (see FIG. 2) and a location-based lookup table 428 to determine a location of the vehicle 10. At operation 430, the method 400 includes obtaining weather data for the location of the vehicle 10 from, for example, an Internet-based weather service. At operations 434, the method 400 includes using vehicle sensor data from one or more sensors 16 and a speed-based lookup table 432 to determine a speed of the vehicle 10.

At operation 436, the method 400 includes determining whether extrinsic parameters of a LiDAR system 14 need to be updated. Here, the extrinsic parameters may be determined to reduce a latency associated with determining a point cloud for autonomously operating the vehicle 10. That is, without having to wait for the LiDAR system(s) 14 to be re-configured. The extrinsic parameters may also be based on one or more intrinsic parameters of the LiDAR system(s) 14 that represent internal configurations of the LiDAR system(s) 14.

At operation 438, the method 400 may include reducing the speed of the vehicle 10. At operation 440, the method 400 includes using image data from one or more cameras 15 that overlap the FOV of the LiDAR system(s) 14 while the LiDAR system(s) 14 are being (re-)configured. Here, the image data may be used for autonomously operating the vehicle 10 while the LiDAR system(s) 14 are being (re-)configured. Here, based on the autonomous driving scenario, one or more extrinsic parameters for the camera(s) 15 may be determined, and the camera(s) 15 may be reconfigured based on the extrinsic parameter(s) for capturing the image data for autonomously operating the vehicle 10.

At operation 442, the method 400 includes calibrating the LiDAR system(s) 14 based on a LiDAR calibration lookup table 444. At operation 446, the method 400 includes monitoring the location and/or speed of the vehicle 10. At operation 448, the method 400 includes obtaining, generating, or acquiring a point cloud (e.g., a panoramic point cloud). At operation 450, the point cloud is used for autonomously operating the vehicle 10. At operation 452, if the location and/or speed are changed, the method 400 includes returning to operation 436.

FIG. 5 is a flowchart of another example arrangement of operations for a method of dynamic condition-based point cloud generation for autonomous driving (e.g., level 4 autonomous driving). The operations may be performed by data processing hardware (e.g., the processor 26) based on executing instructions stored on memory (e.g., the memory hardware 24). Many other ways of implementing the method 500 may be employed. For example, the order of execution of the operations may be changed, and/or one or more of the operations and/or interactions may be changed, eliminated, sub-divided, or combined. Additionally, the operations of FIG. 5 may be carried out sequentially and/or in parallel by, for example, separate processing threads, processors, devices, discrete logic, circuits, etc.

At operation 502, the method 500 includes determining, using one or more LiDAR systems 14, a first point cloud (e.g., a panoramic point cloud) representing an environment of the vehicle 10. At operation 504, the method 500 includes determining, based on the first point cloud, an autonomous driving scenario of the vehicle 10. At operation 506, the method 500 includes determining one or more conditions associated with the autonomous driving scenario. At operation 508, the method 500 includes determining, based on the autonomous driving scenario and the one or more conditions, one or more extrinsic parameters for the LiDAR system(s) 14. Here, the one or more extrinsic parameters for the LiDAR system(s) 14 represent geometric relationships between the LiDAR system(s) 14 and the vehicle 10.

At operation 510, the method 500 includes (re-)configuring the LiDAR system(s) 14 based on the one or more extrinsic parameters. At operation 512, the method 500 includes determining, using the re-configured LiDAR system(s) 14, a second point cloud. At operation 514, the method 500 includes autonomously operating, using the second point cloud, the vehicle 10.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A vehicle comprising:
a light detection and ranging (LiDAR) system;
data processing hardware; and
memory hardware in communication with the data processing hardware and storing instructions that, when executed by the data processing hardware, cause the data processing hardware to perform operations comprising:
determining, using the LiDAR system, a first point cloud representing an environment of the vehicle;
determining, based on the first point cloud, an autonomous driving scenario of the vehicle;
determining one or more conditions associated with the autonomous driving scenario;
determining, based on the autonomous driving scenario and the one or more conditions, one or more extrinsic parameters for the LiDAR system, the one or more extrinsic parameters for the LiDAR system representing a geometric relationship between the LiDAR system and the vehicle;
re-configuring the LiDAR system based on the one or more extrinsic parameters;
determining, using the re-configured LiDAR system, a second point cloud representing an environment of the vehicle; and
autonomously operating, using the second point cloud, the vehicle.

2. The vehicle of claim 1, wherein the operations further comprise, while the LiDAR system is being re-configured:
obtaining image data using a camera; and
using the image data to autonomously operate the vehicle.

3. The vehicle of claim 1, wherein determining the one or more extrinsic parameters for the LiDAR system comprises determining the one or more extrinsic parameters to reduce a latency associated with determining a panoramic point cloud image for autonomously operating the vehicle.

4. The vehicle of claim 1, wherein determining the one or more extrinsic parameters for the LiDAR system is also based on one or more intrinsic parameters of the LiDAR system.

5. The vehicle of claim 1, wherein the operations further comprise:
determining, based on the autonomous driving scenario, one or more extrinsic parameters for a camera of the vehicle, the one or more extrinsic parameters for the camera representing a geometric relationship between the camera and the vehicle;
re-configuring the camera based on the one or more extrinsic parameters for the camera;
obtaining image data using the re-configured camera; and
using the image data together with the second point cloud to autonomously operate the vehicle.

6. The vehicle of claim 1, further comprising a human-machine interface (HMI), wherein the operations further comprise:
detecting, based on the first point cloud, an object in a path of the vehicle; and
based on detecting the object in the path of the vehicle:
alerting an operator of the vehicle of the object in the path of the vehicle in the HMI; and
soliciting, via the HMI, from the operator, a permission to proceed with autonomous driving.

7. The vehicle of claim 6, wherein alerting the operator comprises displaying the object in the HMI such that a colorblind operator can perceive the object.

8. The vehicle of claim 1, wherein the autonomous driving scenario of the vehicle comprises at least one of:
an environmental condition of the vehicle;
a road state;
a weather state;
a detected object;
an operating state of the vehicle;
a vehicle speed;
a location of the vehicle; or
a path of the vehicle.

9. A computer-implemented method executed on data processing hardware that causes the data processing hardware to perform operations comprising:
determining, using a light detection and ranging (LiDAR) system, a first point cloud representing an environment of a vehicle;
determining, based on the first point cloud, an autonomous driving scenario of the vehicle;
determining one or more conditions associated with the autonomous driving scenario;
determining, based on the autonomous driving scenario and the one or more conditions, one or more extrinsic parameters for the LiDAR system, the one or more extrinsic parameters for the LiDAR system representing a geometric relationship between the LiDAR system and the vehicle;
re-configuring the LiDAR system based on the one or more extrinsic parameters;
determining, using the re-configured LiDAR system, a second point cloud representing an environment of the vehicle; and
autonomously operating, using the second point cloud, the vehicle.

10. The computer-implemented method of claim 9, wherein the operations further comprise, while the LiDAR system is being re-configured:
obtaining image data using a camera; and
using the image data to autonomously operate the vehicle.

11. The computer-implemented method of claim 9, wherein determining the one or more extrinsic parameters for the LiDAR system comprises determining the one or more extrinsic parameters to reduce a latency associated with determining a panoramic point cloud image for autonomously operating the vehicle.

12. The computer-implemented method of claim 9, wherein determining the one or more extrinsic parameters for the LiDAR system is also based on one or more intrinsic parameters of the LiDAR system.

13. The computer-implemented method of claim 9, wherein the operations further comprise:
detecting, based on the first point cloud, an object in a path of the vehicle; and
based on detecting the object in the path of the vehicle:
alerting an operator of the vehicle of the object in the path of the vehicle in a human-machine interface (HMI) of the vehicle; and
soliciting, via the HMI, from the operator, a permission to proceed with autonomous driving.

14. The computer-implemented method of claim 9, wherein the operations further comprise:
determining, based on the autonomous driving scenario, one or more extrinsic parameters for a camera of the vehicle, the one or more extrinsic parameters for the camera representing a geometric relationship between the camera and the vehicle;
re-configuring the camera based on the one or more extrinsic parameters for the camera;
obtaining image data using the re-configured camera; and
using the image data together with the second point cloud to autonomously operate the vehicle.

15. A system comprising:
data processing hardware; and
memory hardware in communication with the data processing hardware and storing instructions that, when executed by the data processing hardware, cause the data processing hardware to perform operations comprising:
determining, using a light detection and ranging (LiDAR) system, a first point cloud representing an environment of a vehicle;
determining, based on the first point cloud, an autonomous driving scenario of the vehicle;
determining one or more conditions associated with the autonomous driving scenario;
determining, based on the autonomous driving scenario and the one or more conditions, one or more extrinsic parameters for the LiDAR system, the one or more extrinsic parameters for the LiDAR system representing a geometric relationship between the LiDAR system and the vehicle;
re-configuring the LiDAR system based on the one or more extrinsic parameters;
determining, using the re-configured LiDAR system, a second point cloud representing an environment of the vehicle; and
autonomously operating, using the second point cloud, the vehicle.

16. The system of claim 15, wherein the operations further comprise, while the LiDAR system is being re-configured:
obtaining image data using a camera; and
using the image data to autonomously operate the vehicle.

17. The system of claim 15, wherein determining the one or more extrinsic parameters for the LiDAR system comprises determining the one or more extrinsic parameters to reduce a latency associated with determining a panoramic point cloud image for autonomously operating the vehicle.

18. The system of claim 15, wherein determining the one or more extrinsic parameters for the LiDAR system is also based on one or more intrinsic parameters of the LiDAR system.

19. The system of claim 15, wherein the operations further comprise:
detecting, based on the first point cloud, an object in a path of the vehicle; and
based on detecting the object in the path of the vehicle:
alerting an operator of the vehicle of the object in the path of the vehicle in a human-machine interface (HMI) of the vehicle; and
soliciting, via the HMI, from the operator, a permission to proceed with autonomous driving.

20. The system of claim 15, wherein the operations further comprise:
determining, based on the autonomous driving scenario, one or more extrinsic parameters for a camera of the vehicle, the one or more extrinsic parameters for the camera representing a geometric relationship between the camera and the vehicle;
re-configuring the camera based on the one or more extrinsic parameters for the camera;
obtaining image data using the re-configured camera; and
using the image data together with the second point cloud to autonomously operate the vehicle.
